(19) United States
(12) Patent Application Publication
(10) Pub. No.: US 2014/0116002 A1
(43) Pub. Date: May 1, 2014

(54) PROTECTIVE BODY, HEAT SEALING SYSTEM THAT INCLUDES THE PROTECTIVE BODY, AND METHOD FOR PROVIDING THE PROTECTIVE BODY

(71) Applicant: ILLINOIS TOOL WORKS INC., Glenview, IL (US)

(72) Inventors: Brenda L. Denny, Caneadea, NY (US); Timothy S. Burt, Lancaster, NY (US); Edward Joel Nans, West Seneca, NY (US); Kenneth F. Plucinski, Marilla, NY (US); Diane Noble, Amherst, NY (US); Deborah J. Ashton, Tonawanda, NY (US)

(73) Assignee: Illinois Tool Works Inc., Glenview, IL (US)

(21) Appl. No.: 13/792,921

(22) Filed: Mar. 11, 2013

Related U.S. Application Data
(60) Provisional application No. 61/718,820, filed on Oct. 26, 2012.

(51) Int. Cl. B65B 51/10; B32B 33/00; B32B 27/08

(52) U.S. Cl. CPC B65B 51/10; B32B 27/08; B32B 33/00
USPC 53/329.2; 428/212; 428/447; 156/245

(57) ABSTRACT

A protective body for a heat sealing system is provided. The protective body includes a flexible supporting layer and an exposed layer. The flexible supporting layer has opposite first and second sides. The first side can be coupled to a tool of a heat sealing system. The heat sealing system heat seals a film to a container to enclose the container or to heat seal films together. The exposed layer has a lower coefficient of friction than the supporting layer and is bonded to the second side of the supporting layer. The exposed layer prevents the film that is being heat sealed from sticking to the tool, or to prevent the films being heat sealed together from sticking to the tool.

### CROSS-REFERENCE TO RELATED APPLICATIONS

This application claims priority to U.S. Provisional Application No. 61/718,820, filed 26 Oct. 2012, and entitled “Protective Body, Heat Sealing System That Includes The Protective Body, And Method For Providing The Protective Body,” the entire disclosure of which is incorporated by reference.

### BACKGROUND

A variety of systems can include components that engage one another and/or move relative to each other. For example, heat sealing machines can include tools that apply heat and pressure to seal two or more components together, such as lids or films sealed to a rigid body and/or films that are sealed together. With respect to rigid bodies, the lids or films can be heat sealed to the outer perimeter of an opening of the rigid body to seal and enclose the contents in the rigid body (e.g., a single serving container of food, coffee containers, medical devices in packaging, and the like). With respect to flexible bodies, two or more films can be heat sealed together to seal and enclose the contents in the bag.

Some known heat sealing machines for rigid bodies include a supporting tool that holds the rigid body (e.g., a cup or container) having contents disposed therein and a seal head that applies heat and pressure to a film that is pressed against a perimeter of the exposed opening of the rigid body. The heat and pressure forms a seal between the rigid body and the film around the opening so as to seal and enclose the contents within the rigid body. During repeated operations, however, the seal head can begin to stick to the film and this can result in poor adhesion between the film and the rigid body and/or can result in a seal not being formed. As a result, the contents in the rigid body remain exposed and may spoil or otherwise be damaged.

Some known heat sealing machines for flexible bodies include opposing elongated seal bars on opposite sides of the films that are to be sealed together. As the films move along and between the seal bars, one or more of the seal bars applies heat and pressure to the films in order to seal the films together. This seal can form an enclosure, such as when the films define an opening of a bag. During operation, however, some of the contents in the bag may be expelled from the bag and land on one or more of the seal bars. The expelled contents from the bag can become lodged between the seal bars and the films, and contaminate the interface between the seal bars and the films. As a result, the films of a current bag and/or subsequent bags may not receive sufficient heat and/or pressure to seal the films together. As a result, the contents in the bag may remain exposed and may spoil or otherwise be damaged.

### BRIEF SUMMARY

In an embodiment, a protective body for a heat sealing system is provided. The protective body includes a flexible supporting layer and an exposed layer. The flexible supporting layer has opposite first and second sides. The first side is configured to be coupled to a tool of a heat sealing system (e.g., a mounting mechanism of a seal head, a seal jaw, or the like). The heat sealing system is configured to heat seal a film to a container to enclose the container or to heat seal two or more films together. The exposed layer has a lower coefficient of friction than the supporting layer and is bonded to the second side of the supporting layer. The exposed layer is configured to prevent the film that is being heat sealed to the container from sticking to the tool when the heat sealing system heat seals the film to the container, or to prevent the two or more films that are heat sealed together by the heat sealing system from sticking to the tool when the heat sealing system heat seals the two or more films together.

In an embodiment, a method (e.g., for providing a protective body of a heat sealing system) includes positioning a polytetrafluoroethylene (PTFE) layer into a mold, loading non-vulcanized silicone material onto the PTFE layer, placing a mounting mechanism onto the non-vulcanized silicone material, and applying at least one of heat or pressure to the silicone material to form a silicone layer that is bonded to the PTFE layer and to the mounting mechanism. The silicone layer and the PTFE layer form the protective body that is configured to be connected to a tool of a heat sealing system that is configured to heat seal a film to a container to enclose the container or to a tool of a heat sealing system that is configured to heat seal two or more films together. The PTFE layer is configured to prevent at least one of the films being heat sealed to the container or the two or more films from sticking to the tool when the heat sealing system heat seals the film to the container or the two or more films together.

In an embodiment, a seal head for a heat sealing system includes a mounting mechanism, a flexible supporting layer, and exposed layer. The mounting mechanism is configured to move toward a supporting tool of the heat sealing system that is configured to hold a container. The mounting mechanism is configured to move toward the supporting tool to apply pressure to a film being heat sealed to the container. The supporting layer is configured to be bonded to the mounting mechanism. The exposed layer is configured to be bonded to the supporting layer such that the supporting layer is disposed between the mounting mechanism and the exposed layer. The exposed layer is configured to prevent the film being heat sealed to the container from sticking to the mounting mechanism when the heat sealing system heat seals the film to the container and the mounting mechanism moves away from the supporting tool.

In an embodiment, a protective body (e.g., for a heat sealing system) includes a thermally conductive silicone layer and a polytetrafluoroethylene (PTFE) layer. The silicone layer has opposite first and second sides. The first side is configured to engage a tool of a heat sealing system to couple the supporting layer to the tool. The heat sealing system is configured to heat seal a film to a container to enclose the container or to heat seal two or more films together. The PTFE layer is bonded to the second side of the supporting layer. The silicone layer is configured to couple the PTFE layer to the tool. The PTFE layer is configured to prevent the film being heat sealed to the container when the heat sealing system heat seals the film to the container or to prevent the two or more films from sticking to the tool when the heat sealing system heat seals the two or more films together.

### BRIEF DESCRIPTION OF THE DRAWINGS

Reference is now made briefly to the accompanying drawings, in which:

FIG. 1 is a side view of an embodiment of a protective body;

FIG. 2 is a schematic view of an embodiment of a heat sealing system that uses the protective body shown in FIG. 1;

FIG. 3 is a cross-sectional view of the heat sealing system along line A-A in shown in FIG. 2 in accordance with one example;

FIG. 4 is another cross-sectional view of the heat sealing system along line A-A in shown in FIG. 2 in accordance with one example;

FIG. 5 is another cross-sectional view of the heat sealing system along line A-A in shown in FIG. 2 in accordance with one example;

FIG. 6 illustrates a cross-sectional view of the heat sealing system along line A-A shown in FIG. 2 in accordance with another embodiment;

FIG. 7 illustrates a cross-sectional view of the heat sealing system along line A-A shown in FIG. 2 in accordance with another embodiment;

FIG. 8 illustrates a cross-sectional view of the heat sealing system along line A-A shown in FIG. 2 in accordance with another embodiment;

FIG. 9 is a schematic view of another embodiment of a heat sealing system that uses the protective body shown in FIG. 1;

FIG. 10 is another schematic view of the heat sealing system shown in FIG. 9;

FIG. 11 is a schematic view of seal bars of the sealing system shown in FIG. 9;

FIG. 12 illustrates an embodiment of how the protective body shown in FIG. 1 can be created;

FIG. 13 illustrates an embodiment of how the protective body shown in FIG. 1 can be created;

FIG. 14 is a flowchart of an embodiment of a method for providing a protective body;

FIG. 15 illustrates another embodiment of how the protective body shown in FIG. 1 can be created;

FIG. 16 illustrates another embodiment of how the protective body shown in FIG. 1 can be created;

FIG. 17 illustrates another embodiment of how the protective body shown in FIG. 1 can be created; and

FIG. 18 illustrates another embodiment of how the protective body shown in FIG. 1 can be created; and

FIG. 19 is a flowchart of another embodiment of a method for manufacturing a protective body.

### DETAILED DESCRIPTION

One or more embodiments of the inventive subject matter described herein relate to a protective body formed from polytetrafluoroethylene (PTFE) and thermally conductive silicone that is used with heat sealing systems to increase the reliability of the heat sealing systems in creating seals for rigid bodies and/or flexible films. The protective body can reduce sticking between tools of the heat sealing systems and the films or sheets being heat sealed, and/or can prevent the tools of the systems from being contaminated with the contents in the bodies being sealed.

In an embodiment, the protective body is formed as a sheet having an supporting layer formed from a layer of silicone and an exposed layer (e.g., an upper layer) formed from PTFE (e.g., Teflon™ or other similar material) that is bonded to the supporting layer of silicone. The exposed layer of PTFE prevents a film being sealed to a rigid body from sticking to a tool (e.g., a seal head) that is applying pressure and heat onto the film. Alternatively or additionally, the exposed layer of PTFE can prevent contents of a flexible body (e.g., a bag) from contaminating the tools (e.g., seal bars) that are sealing the flexible body. For example, the exposed layer of PTFE can prevent the expelled contents from a bag from remaining between the seal bars and the films being sealed to enclose the bag.

Several examples of applications in which the PTFE-silicone body may be used are provided herein. The scope of the inventive subject matter described herein, however, is not to be limited to these example applications. Additional uses and applications of the PTFE-silicone body may fall within the scope of the inventive subject matter.

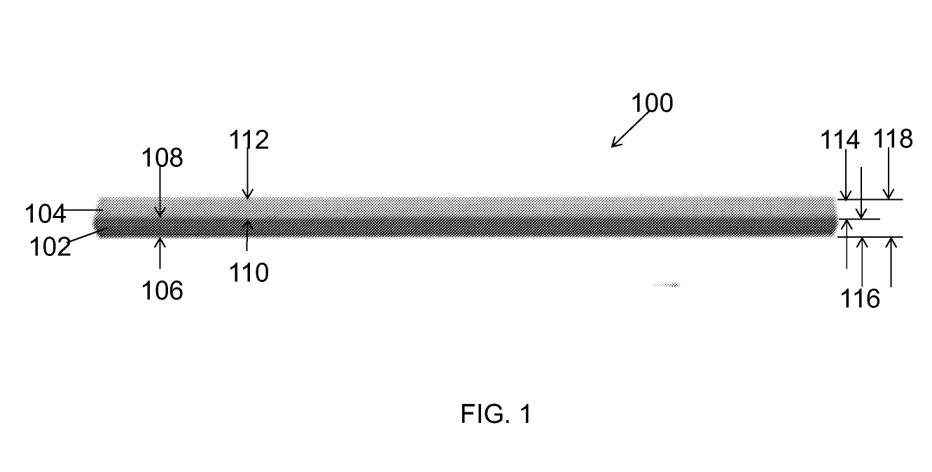

FIG. 1 is a side view of an embodiment of a protective body 100. The protective body 100 includes a supporting layer 102 formed from a flexible material such as silicone, and an exposed layer 104 formed from a non-stick material, such as PTFE. The protective body 100 may be provided as a sheet or other substantially planar form. Additionally or alternatively, the protective body 100 may be provided as a gasket or non-planar shape or form. The supporting layer 102 can be a flexible material, such as silicone, while still being thermally conductive. For example, the supporting layer 102 may be relatively thin and flexible so that the supporting layer 102 can take a variety of shapes, provide for increased tolerances during use (e.g., when the supporting layer 102 is positioned between two or more components and one or more of the components moves, as described below), and thermally conduct heat in a heat sealing system.

The supporting layer 102 extends between an engagement side 106 and an opposite bonding side 108. The engagement side 106 is coupled to the tool or other component of a heat sealing machine to which the protective body 100 is coupled. For example, the engagement side 106 may directly abut the surface of a seal head or a seal bar. The engagement side 106 can be bonded to the surface of the tool.

The exposed layer 104 extends between a bonding side 110 and an opposite side 112. The bonding side 110 directly abuts the bonding side 108 of the supporting layer 102 in the illustrated embodiment. For example, the bonding side 110 may directly bond (e.g., via chemical bonds) with the bonding side 108 of the supporting layer 102. In an embodiment, the bonding side 108 of the supporting layer 102 may be treated before engaging the exposed layer 104. Such a treatment can include preparing the bonding side 108 of the supporting layer 102 with one or more chemicals or compounds that cause the bonding side 108 of the supporting layer 102 to bond or couple with the bonding side 110 of the exposed layer 104.

As shown in FIG. 1, the exposed layer 104 may have a thickness dimension 114 that is smaller than a thickness dimension 116 of the supporting layer 102. The thickness dimension 114 is measured in a direction that extends as a normal to one or more of the sides 110, 112 of the exposed layer 104 and from one side 110 or 112 to the other side 112 or 110. The thickness dimension 116 is measured in a direction that extends as a normal to one or more of the sides 106, 108 of the supporting layer 102 and from one side 106 or 108 to the other side 108 or 106. A total thickness dimension 118 of the protective body 100 can be measured in a direction that extends as a normal to one or more of the sides 106, 112 and from one side 106 or 112 to the other side 112 or 106. In an embodiment, the total thickness dimension 118 is equivalent to a sum of the thickness dimensions 114, 116. For example, no adhesive or other material may be present between the supporting layer 102 and the exposed layer 104.

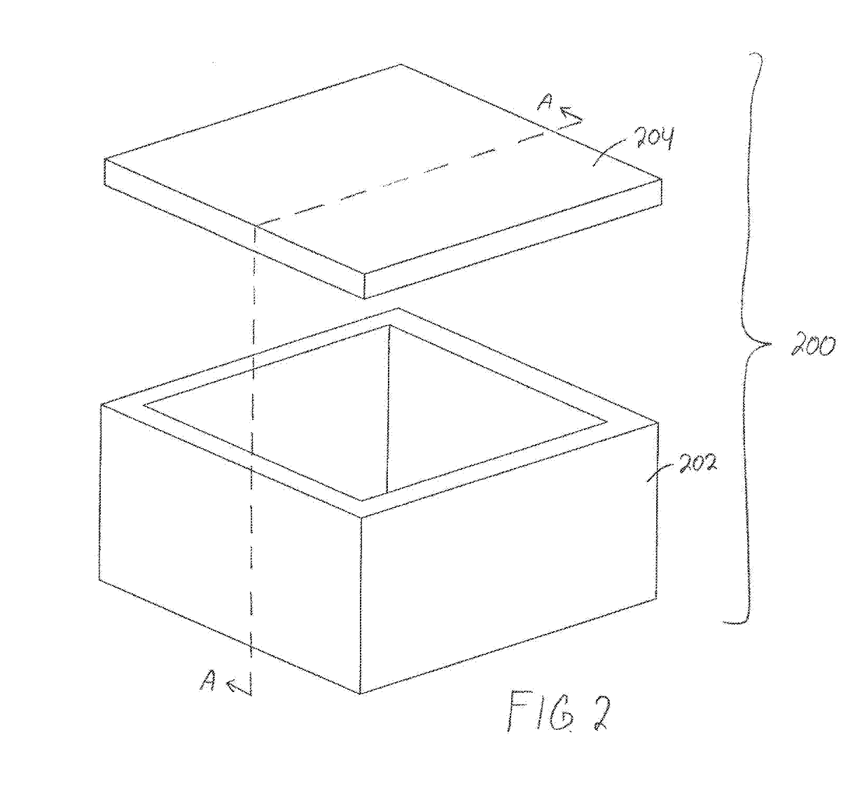

FIG. 2 is a schematic view of an embodiment of a heat sealing system 200 that uses the protective body 100. The heat sealing system 200 is used to heat seal a film (e.g., a lid) to a container formed from a rigid or semi-rigid material (e.g., a cup, bowl, or the like). The heat sealing system 200 includes a supporting tool 202 and a seal head 204. Although not shown in FIG. 2, the seal head 204 and/or the supporting tool 202 may be connected to one or more additional components, such as one or more apparatuses that generate heat in the seal head 204 and/or tool 202, that move the seal head 204 and/or the tool 202 toward each other, or the like. The seal head 204 includes a mounting mechanism 206, such as a thermally conductive body formed from a metal or metal alloy. The mounting mechanism 206 can be a mounting block, connector, or other device to which the protective layer 100 may be coupled.

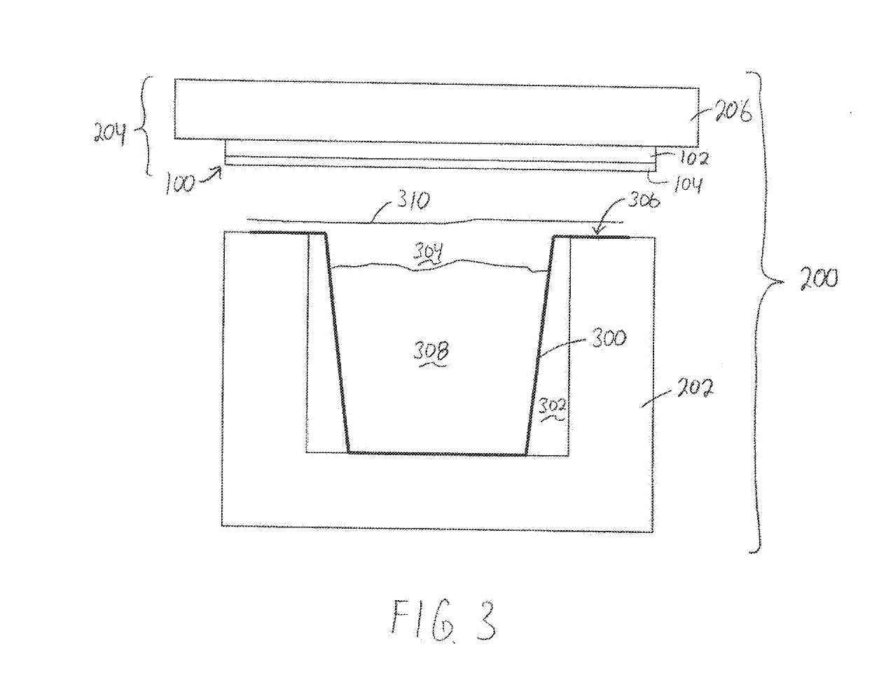

FIG. 3 is a cross-sectional view of the heat sealing system 200 along line A-A as shown in FIG. 2 in accordance with one example. A container body 300 is loaded into an open chamber 302 that is defined by the supporting tool 202. In the illustrated embodiment, the container body 300 is a cup or bowl that defines an interior chamber 304. The container body 300 may include a lip or ledge 306 that extends around a perimeter of and defines an opening to the interior chamber 304. A product 308 may be contained within the container body 300. For example, food (e.g., coffee or the like), medical devices, or other goods may be disposed within the interior chamber 304 of the container body 300. The lid 310 includes a film or other body that can be sealed to the lip or ledge 306 of the container body 300 when pressure and heat are applied to press the lid 310 and the lip or ledge 306 together.

The protective body 100 is coupled with the mounting mechanism 206 of the seal head 204 so that the exposed layer 104 faces the supporting tool 202. For example, the supporting layer 102 may be coupled with a lower face or side of the mounting mechanism 206 so that the exposed layer 104 faces the supporting tool 202. As described below, the supporting layer 102 may be applied to the mounting mechanism 206 in an uncured state and then cured while in contact with the mounting mechanism 206. The supporting layer 102 may then be bonded with the mounting mechanism 206 so that the supporting layer 102 does not easily separate from the mounting mechanism 206.

In operation, the seal head 204 is separated from the supporting tool 202, the container 300 is placed into the supporting tool 202, and the lid 310 is positioned between the seal head 204 and the container 300 in the supporting tool 202. This arrangement is shown in FIG. 3. The seal head 204 then moves toward the supporting tool 202 and/or the supporting tool 202 is moved toward the seal head 204 so that the lid 310 concurrently contacts both the protective body 100 of the seal head 204 and the container 300 held in the supporting tool 202.

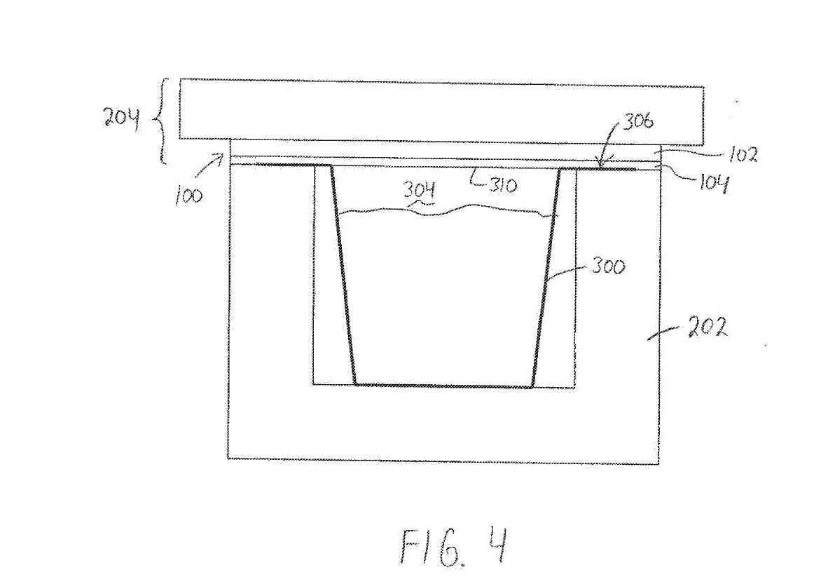

FIG. 4 is another cross-sectional view of the heat sealing system 200 along line A-A in shown in FIG. 2 in accordance with one example. The seal head 204 is shown in a sealing position where pressure and/or heat is applied to the lid 310 by the seal head 204 in order to heat seal the lid 310 to the container 300. For example, the seal head 204 may be forced downward and/or the supporting tool 202 may be forced upward to compress the lid 310 between the protective body 100 on the seal head 204 and the supporting tool 202. Heat may be transferred through the seal head 204 (e.g., from one or more heating elements that are connected with the seal head 204). The supporting layer 102 can be formed from thermally conductive silicone such that the heat from the seal head 204 is conducted to the lid 310 and the interface between the lid 310 and the lip or ledge 306 of the container 300. For example, the thermal conductivity of the supporting layer 102 may be greater than or equal to 0.22 W/mK. The supporting layer 102 may be flexible so that the seal head 204 can apply even pressure to the interface between the lid 310 and the lip or ledge 306, while still providing for some manufacturing tolerance.

The seal head 204 applies heat and/or pressure to the interface between the lid 310 and the lip or ledge 306 for a sufficient time that the lid 310 is sealed to the lip or ledge 306 around the perimeter of the opening to the interior chamber 304 of the container 300. Once this seal is formed, the seal head 204 can separate from the supporting tool 202.

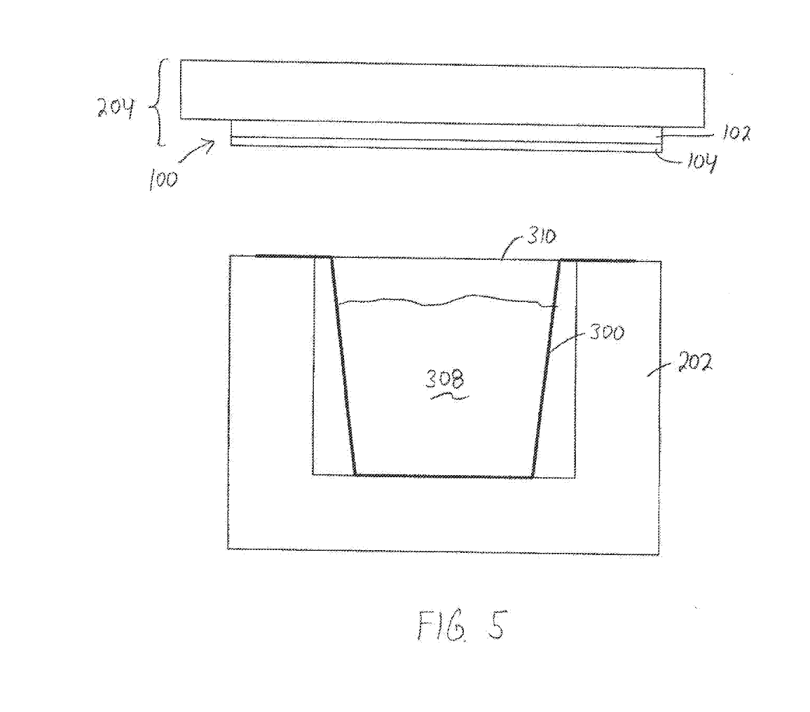

FIG. 5 is another cross-sectional view of the heat sealing system 200 along line A-A as shown in FIG. 2 in accordance with one example. After heat sealing the lid 310 to the container 300, the seal head 204 can disengage from the lid 310 by moving the seal head 204 away from the supporting tool 202 and/or moving the supporting tool 202 away from the seal head 204. As the seal head 204 disengages from the supporting tool 202, the exposed layer 104 prevents the lid 310 from sticking to the seal head 204. For example, the PTFE of the exposed layer 104 has a relatively low coefficient of friction and, as a result, the lid 310 may be less likely to stick or adhere to the seal head 204 due to the exposed layer 104 (relative to the mounting mechanism 206). For example, the exposed layer 104 may have a coefficient of friction that is lower than the coefficient of friction of the supporting layer 102, the lid 310, the supporting tool 202, the mounting mechanism 206, and/or the container 300. The lid 310 is more likely to remain sealed to the container 300 to thereby keep the contents 308 sealed in the container 300.

Over time, the exposed layer 104 may wear down and need to be replaced. In order to do so, an operator may remove the seal head 204 from the system 200 and replace the seal head 204 with another seal head 204 having the protective body 100 (with the exposed layer 104). Alternatively, the protective body 100 may be removed from the seal head 204 and another protective body 100 may be coupled with the seal head 204.

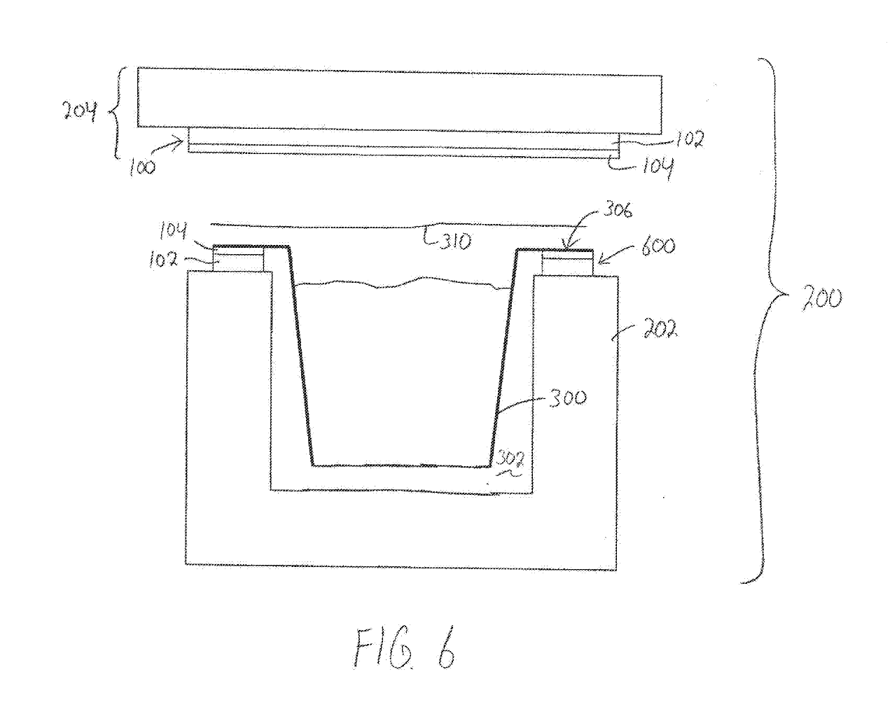

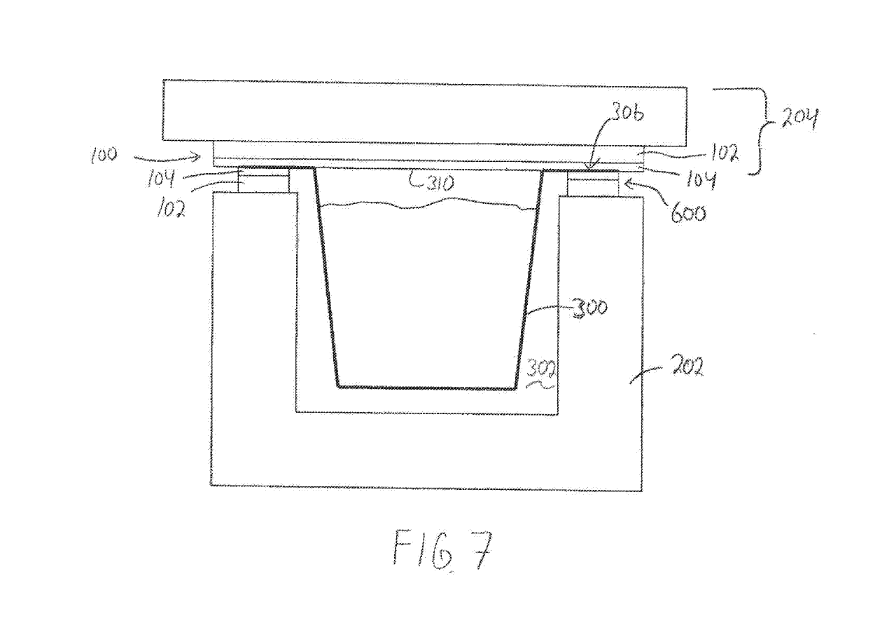

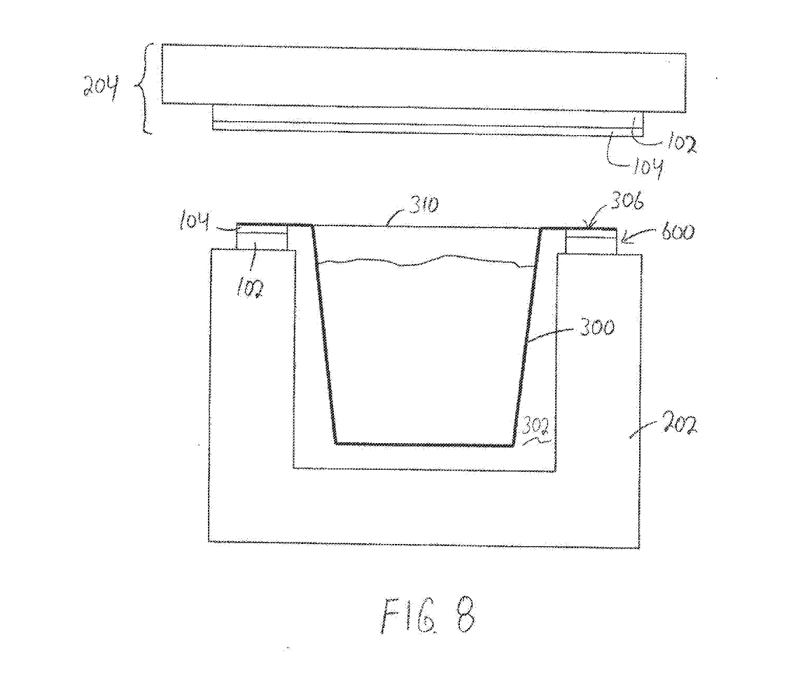

FIGS. 6 through 8 illustrate cross-sectional views of the heat sealing system 200 along line A-A shown in FIG. 2 in accordance with another embodiment. The heat sealing system 200 in FIGS. 6 through 8 includes a gasket 600 that is formed from the protective body 100. For example, the gasket 600 may be a ring that extends around the interior chamber 302 of the supporting tool 202 and that includes the supporting layer 102 and the exposed layer 104. The supporting layer 102 is coupled with the supporting tool 202 and the exposed layer 104 faces the lip or ledge 306 of the container 300. The lip or ledge 306 of the container 300 may rest on the gasket 600 when the container 300 is loaded into the supporting tool 202. The gasket 600 may be bonded to the supporting tool 202, or may be separate from and rest upon the supporting tool 202.

Similar to as described above in connection with FIGS. 4 and 5, the seal head 204 and the supporting tool 202 can compress the lid 310 and the lip or ledge 306 of the container 300 together while applying heat. If heat is applied from the supporting tool 202, the heat can be conducted through the thermally conductive silicone of the supporting layer 102 in the gasket 600 to the interface between the lip or ledge 306 of the container 300 and the lid 310. The flexibility of the supporting layer 102 can assist in ensuring that even pressure is applied to the interface between the lid 310 and the lip or ledge 306, while still providing for manufacturing tolerance.

After heat sealing the lid 310 to the container 300, the seal head 204 can disengage from the lid 310 and/or the supporting tool 202 by moving the seal head 204 away from the supporting tool 202 and/or moving the supporting tool 202 away from the seal head 204. As the seal head 204 disengages from the supporting tool 202, the exposed layer 104 of the protective body 100 prevents the lid 310 from sticking to the seal head 204 and the exposed layer 104 of the gasket 600 can prevent the lip or ledge 306 from sticking to the supporting tool 202.

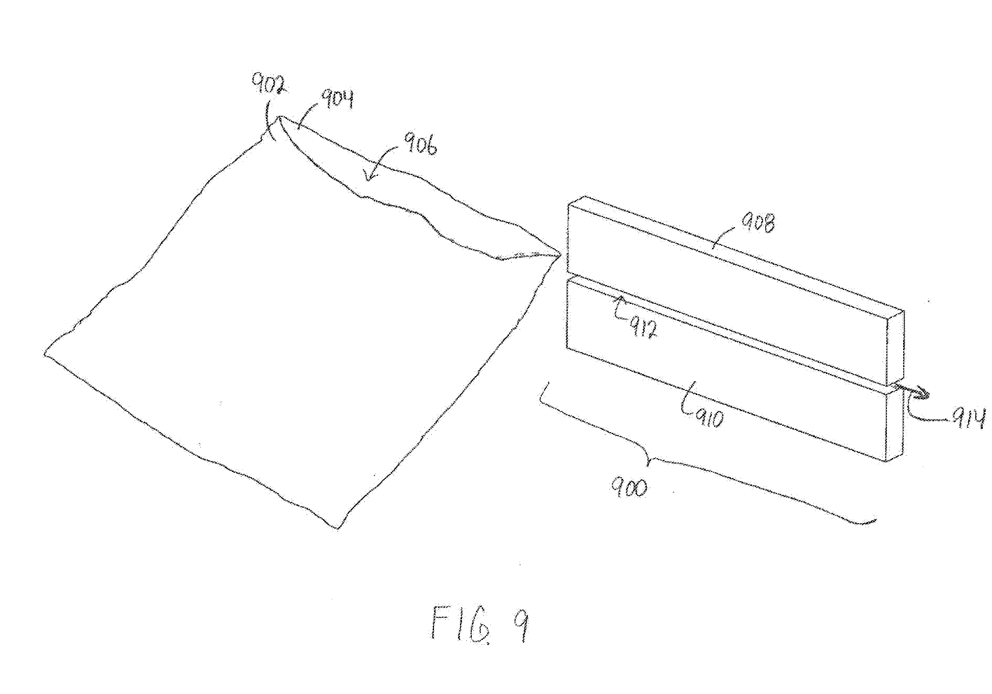

FIG. 9 is a schematic view of another embodiment of a heat sealing system 900 that uses the protective body 100. The heat sealing system 900 is used to heat seal two or more films 902, 904 (e.g., films, sides of a bag, or the like) to each other. In one example, the heat sealing system 900 can heat seal two films 902, 904 on opposite sides of an opening 906 of a bag in order to seal the bag closed.

The heat sealing system 900 includes opposing seal bars 908, 910 that are separated from each other by a clearance passageway 912. The seal bars 908, 910 are elongated parallel to a direction of travel 914 of the films 902, 904 through the heat sealing system 900. In operation, one or more of the seal bars 908, 910 are heated and the films 902, 904 are moved through the clearance passageway 912 between the seal bars 908, 910. The seal bars 908, 910 may be separated by a sufficiently small distance in the clearance passageway 912 to impart a compressive force (e.g., pressure) on the films 902, 904, while still allowing the films 902, 904 to move between the seal bars 908, 910 along the direction of travel 914. The films 902, 904 are moved horizontally between the seal bars 908, 910 in the illustrated embodiment. Alternatively, the seal bars 908, 910 could be vertically oriented such that the films 902, 904 are moved between the seal bars 908, 910 in a vertical direction.

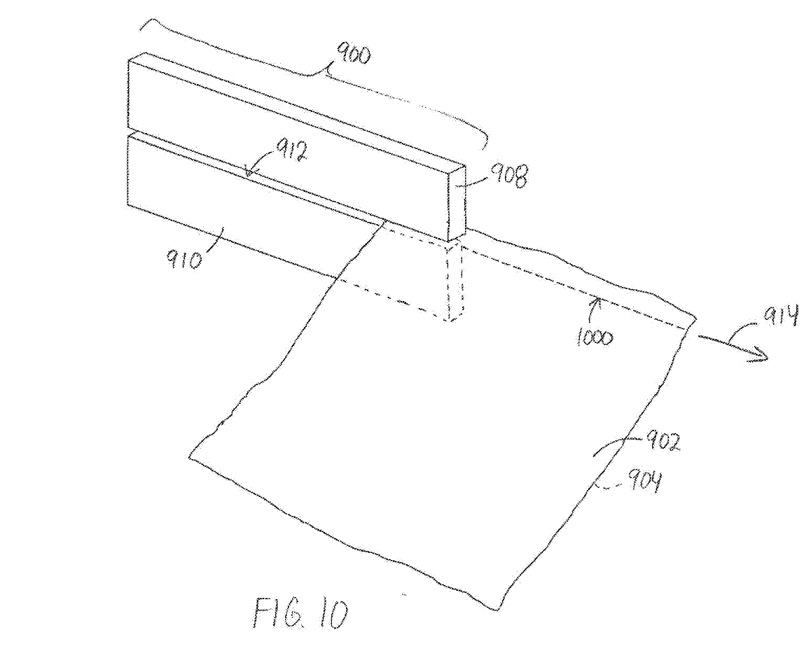

FIG. 10 is another schematic view of the heat sealing system 900 shown in FIG. 9. As the films 902, 904 are moved between the seal bars 908, 910, the heat and pressure applied to the films 902, 904 from the seal bars 908, 910 can cause the films 902, 904 to contact and be sealed to each other. The films 902, 904 may be coupled together along a seal 1000, as shown in FIG. 10. This sealing of the films 902, 904 may close the opening 906 (shown in FIG. 9) of a bag that includes the films 902, 904. The films 902, 904 can continue to be moved through the clearance passageway 912 between the seal bars 908, 910 along the direction of travel 914 until the films 902, 904 are removed from between the seal bars 908, 910.

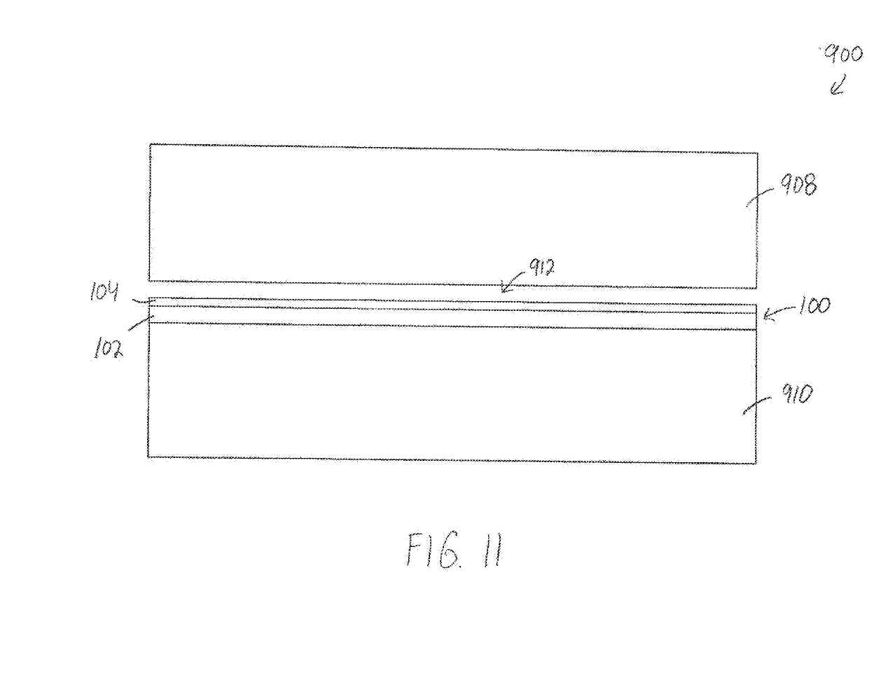

FIG. 11 is a schematic view of the seal bars 908, 910 of the sealing system 900 shown in FIG. 9. In the illustrated embodiment, the seal bar 910 includes the protective body 100 disposed between the seal bar 910 and the seal bar 908. Alternatively, the protective body 100 may be coupled with the seal bar 908. The protective body 100 is coupled with the seal bar 910 such that the exposed layer 104 of the protective body 100 faces the seal bar 908. The protective body 100 is disposed in the clearance passageway 912 such that one or more of the films 902, 904 engage the protective body 100 as the films 902, 904 move between the seal bars 908, 910.

For example, when the films 902, 904 move through the clearance passageway 912, the film 904 may engage and slide along the exposed layer 104 of the protective body 100. The exposed layer 104 may have a relatively low coefficient of friction and, as a result, the film 904 may more easily move along the exposed layer 104 without becoming stuck to the protective body 100 or seal bar. Additionally, contents of the bag that is formed by the films 902, 904 may fall out or otherwise become expelled from inside the bag prior to forming the seal 1000. For example, coffee grounds, food, or other goods or other contaminants (e.g., dust, metal shavings, and the like) may land on the exposed layer 104 of the protective body 100. Due at least in part to the relatively low coefficient of friction of the exposed layer 104, these contaminants (e.g., contents of the bag or other materials) may not remain on the exposed layer 104 and between the films 902, 904 and the exposed layer 104. The movement of the film 902 or 904 across the exposed layer 104 can remove the contaminants from the exposed layer 104. Without removing these contaminants, the contaminants may prevent the seal bar 910 from sufficiently heating or compressing the films 902, 904 so as to create the seal 1000.

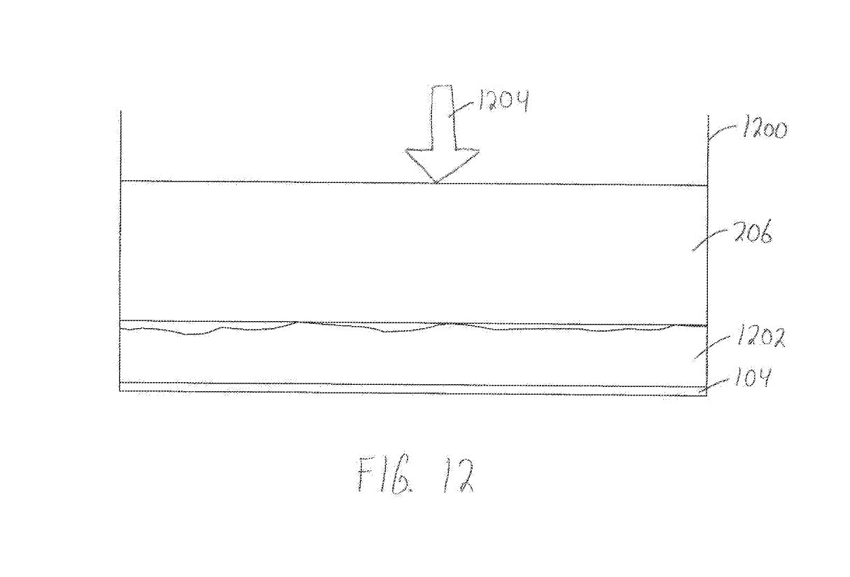

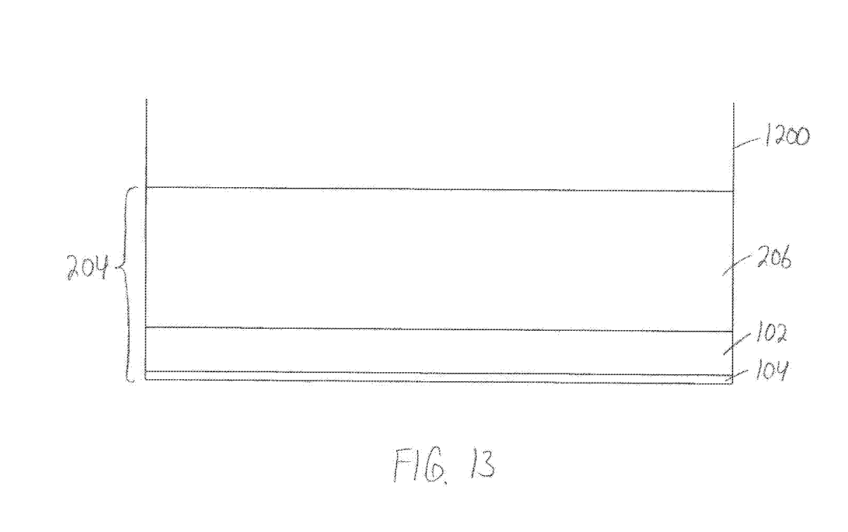

FIGS. 12 and 13 illustrate an embodiment of how the protective body 100 can be created. The embodiment shown in FIGS. 12 and 13 focuses on fabrication of the protective body 100 that is applied to the mounting mechanism 206 of the seal head 204, but alternatively may be used for fabrication of the protective body 100 as the gasket 600 or another shape (e.g., a thin, elongated shape used with a seal bar).

As shown in FIG. 12, the exposed layer 104 may be positioned inside a mold 1200, such as along a bottom surface of a box, bin, or other device. A body 1202 of the material used to create the supporting layer 102 is placed onto the protective layer 104. For example, prior to curing or vulcanization, the silicone material that is used to create the supporting layer 102 may have a relatively soft and malleable consistency. Once this body 1202 of material is placed onto the exposed layer 104, the mounting mechanism 206 can be placed onto the body 1202 of the material used to form the supporting layer 102.

Pressure is applied to the mounting mechanism 206 (e.g., along the direction indicated by arrow 1204 in FIG. 12) so that the body 1202 of the material used to form the supporting layer 102 is compressed between the mounting mechanism 206 and the exposed layer 104. Heat is applied, such as by placing the mold 1200 with the mounting mechanism 206, the body 1202, and the supporting layer 102 in a machine press (e.g., an oven under pressure), in order to cure or vulcanize the body 1202 into the supporting layer 102. As shown in FIG. 13, when the material is cured or vulcanized into the supporting layer 102, the supporting layer 102 is bonded to the mounting mechanism 206 of the seal head 204 and the exposed layer 104. The seal head 204 may then be removed from the mold 1200 and used in a heat sealing machine, as described herein.

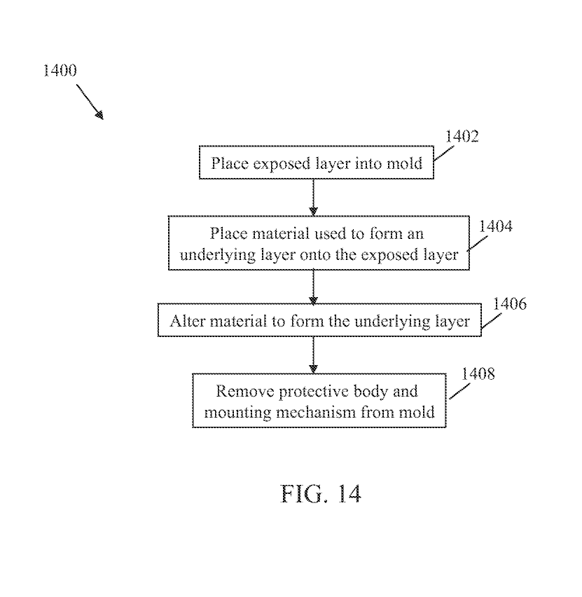

FIG. 14 is a flowchart of an embodiment of a method 1400 for manufacturing a protective body. The method 1400 may be used to provide the protective bodies 100 described above, such as the protective body 100 that is bonded to the mounting mechanism 206 to form the seal head 204. At 1402, the exposed layer 104 is loaded into a mold. For example, a layer of PTFE may be placed onto the bottom surface of the mold 1200.

At 1404, the body 1202 of material that is used to form the supporting layer 102 is placed onto the exposed layer 104. For example, uncured silicone or silicone that has not yet been vulcanized may be placed onto the exposed layer 104 that is in the mold 1200.

At 1406, the body 1202 of the material in the mold 1200 is altered to form the supporting layer 102. For example, heat, pressure, and/or another catalyst may be applied to the body 1202 of the material in the mold 1200 to cause the body 1202 to cure or vulcanize. The cured or vulcanized material forms the supporting layer 102. During curing or vulcanization, the body 1202 of material may bond to the exposed layer 104 and the mounting mechanism 206 disposed in the mold 1200. The supporting layer 102 and exposed layer 104 are now formed into the protective body 100 that is bonded to the mounting mechanism 206.

At 1408, the protective body 100 and the mounting mechanism 206 are removed from the mold 1200. The protective layer 100 and the mounting mechanism 206 may be removed from the mold 1200 as the seal head 204 described above.

In an embodiment, the method 1400 may be used to retrofit an existing tool, such as a seal head, with the protective body 100. For example, a seal head that previously has a protective body 100 bonded thereto may need to have the exposed layer 104 replaced. The supporting layer 102 may be removed from the mounting mechanism 206 of the seal head and the mounting mechanism 206 may then be placed into a mold. The method 1400 may then be used to add a new or replacement protective body 100 to the mounting mechanism 206 of the seal head 204. Alternatively, the method 1400 may be used to add the protective body 100 to a seal head that has not previously had the protective body 100 bonded thereto.

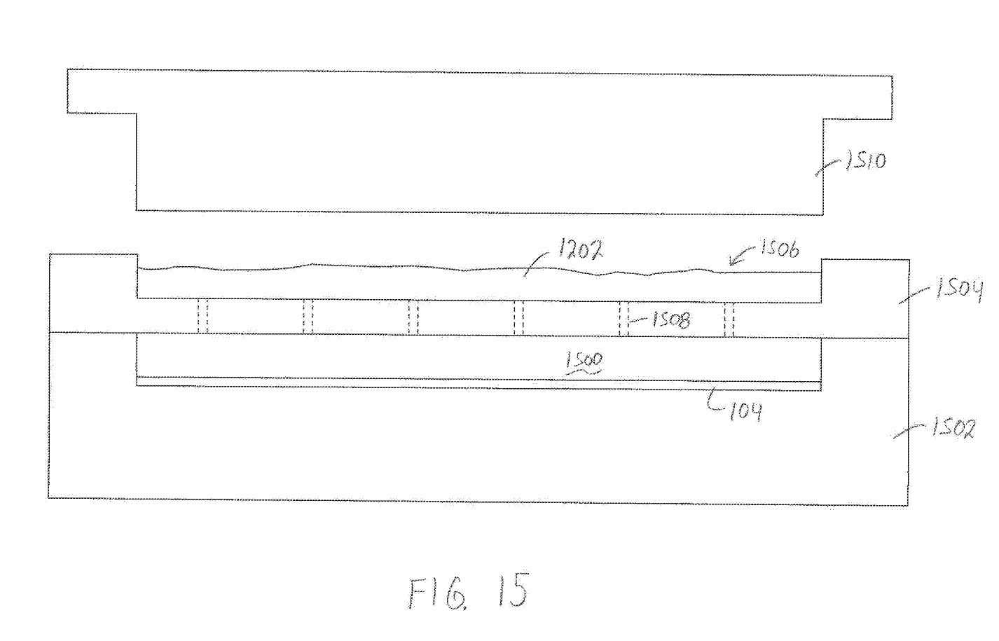

FIGS. 15 through 18 illustrate another embodiment of how a protective body, such as the protective body 100 that is not bonded to any surface, the gasket 600, or the like, can be created. The exposed layer 104 may be positioned inside a mold cavity 1500 that is formed from a mold plate 1502, such as along a bottom interior surface of a box, bin, or other device. A middle plate 1504 is placed onto the mold cavity 1500 above the exposed layer 104 and separated from the exposed layer 104. For example, the middle plate 1504 may be spaced apart from the exposed layer 104 to define the size of the mold cavity 1500.

The middle plate 1504 includes a pot 1506, such as a recessed area, and one or more orifices 1508 extending through the middle plate 1504 from the area of the pot 1506 to the bottom side of the middle plate 1504 that faces the mold cavity 1500. The orifices 1508 provide access to the mold cavity 1500 from the pot 1506. The orifices 1508 represent sprew holes in the illustrated embodiment, but alternatively may represent one or more other openings, channels, or other holes extending through the thickness of the middle plate 1504.

The body 1202 of the material used to create the supporting layer 102 is placed into the pot 1506 of the middle plate 1504. For example, prior to curing or vulcanization, a body 1202 of the silicone material that is used to create the supporting layer 102 may have a relatively soft and malleable consistency. This body 1202 can be positioned in the pot 1506 of the middle plate 1504.

A pusher plate 1510 is positioned above the body 1202 of material in the pot 1506. As shown in FIGS. 15 through 17, the pusher plate 1510 can be moved toward the mold cavity 1500 while the middle plate 1504 remains stationary. The pusher plate 1510 may move downward so as to engage and push the body 1202 of material through one or more of the orifices 1508 of the middle plate 1504 into the mold cavity 1500.

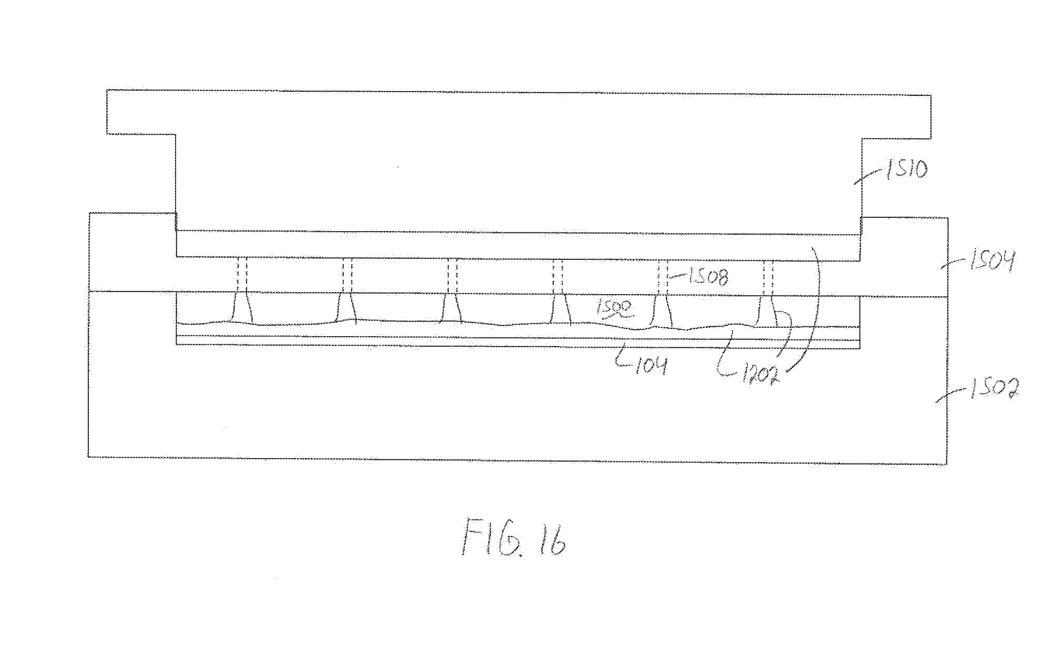

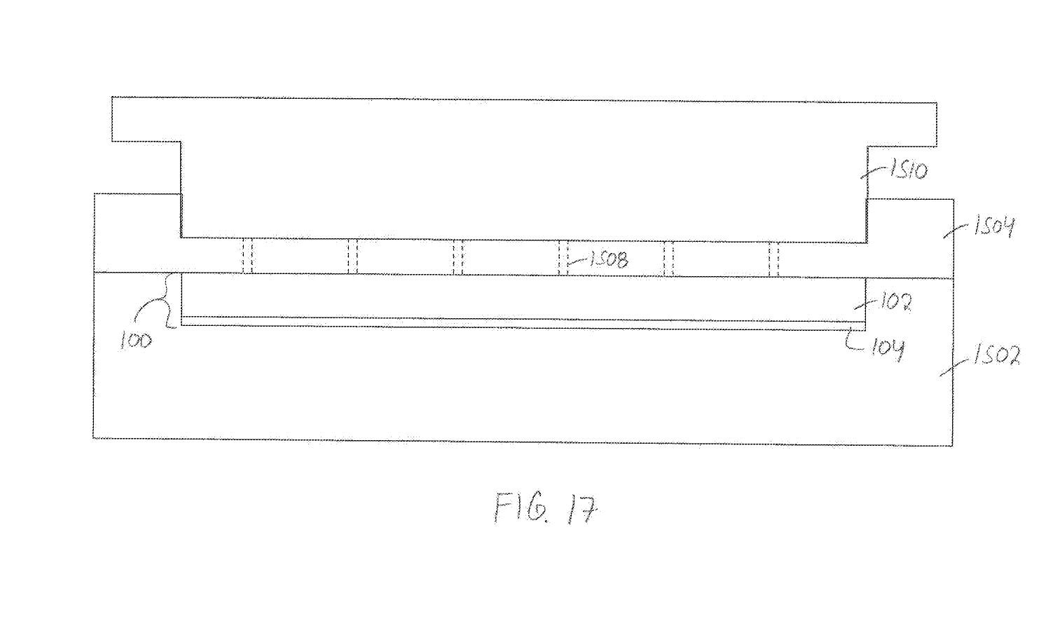

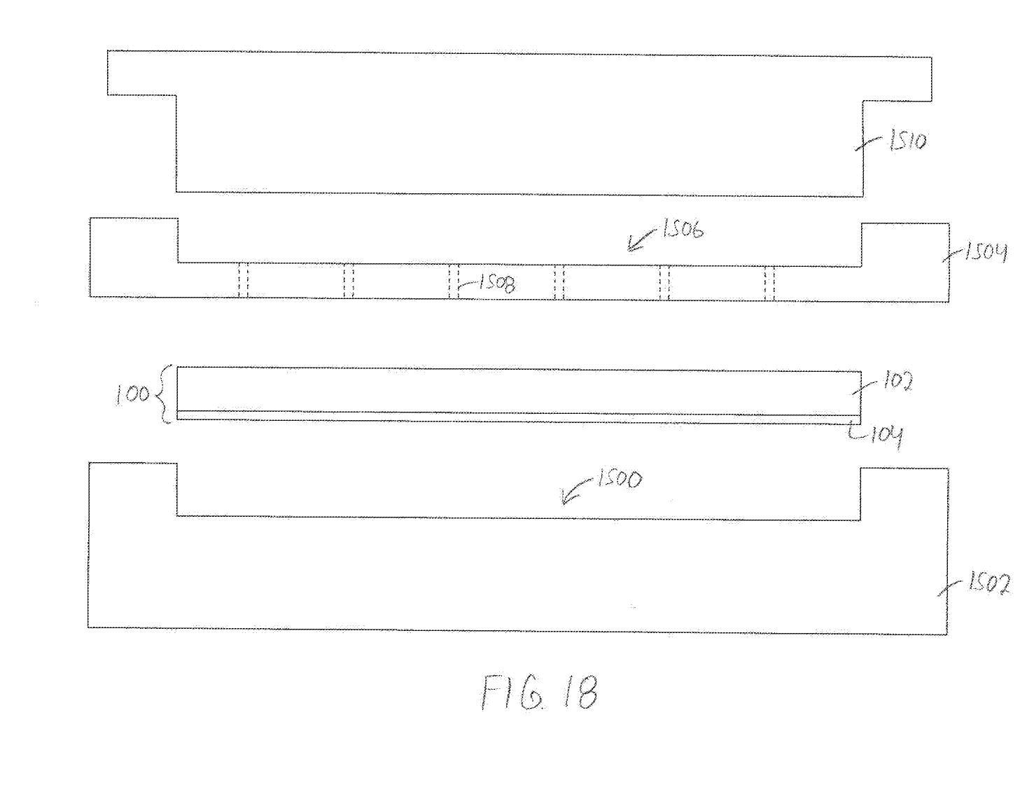

The flow of the body 1202 of the material through the orifices 1508 causes the body 1202 of the material to be injected into the mold cavity 1500, as shown in FIG. 16. Heat is applied to the material of the body 1202 as the material is injected into the mold cavity 1500. The pressure applied to the body 1202 of the material as the material is injected into the mold cavity 1500 and this heat and pressure can cure the material into the supporting layer 102, as shown in FIG. 17. The supporting layer 102 is bonded to the exposed layer 104 to form the protective body 100. As shown in FIG. 18, the pusher and middle plates 1510, 1504 may be removed from the mold plate 1502 to allow the protective body 100 to be removed from the mold cavity 1504. Depending on the size and shape of the mold cavity 1500, the protective body 100 that is formed can be in a variety of shapes, such as a shape that then can be coupled to the mounting mechanism 206 to form the seal head 204, a shape that may be used as the gasket 600, a shape that can be coupled to the seal bar 908, or another shape.

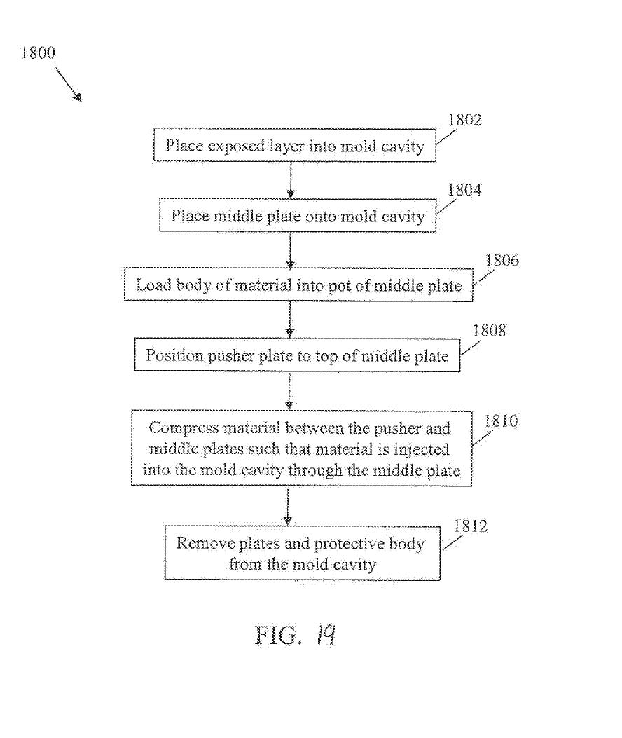

FIG. 19 is a flowchart of another embodiment of a method 1800 for manufacturing a protective body. The method 1800 may be used to provide the protective bodies 100 described above, such as the gasket 600, the protective body 100 coupled to the seal bar 908, and the like.

At 1802, the exposed layer 104 is loaded into a mold cavity. For example, a layer of PTFE may be placed onto the bottom surface of the mold cavity 1500 in the mold cavity 1504. At 1804, the middle plate 1504 is placed onto the mold cavity 1500 above the exposed layer 104. As described above, the middle plate 1504 may be spaced apart from the exposed layer 104 to define the mold cavity 1504 in the mold plate 1502.

At 1806, the body 1202 of material that is used to form the supporting layer 102 is placed into the pot 1506 of the middle plate 1504. For example, uncured silicone or silicone that has not yet been vulcanized may be placed into the pot 1506 of the middle plate 1504. At 1808, the pusher plate 1510 is placed into the top of the middle plate 1504. The pusher plate 1510 may be placed above the body 1202 of the material used to form the supporting layer 102 such that the body 1202 is disposed between the middle plate 1504 and the pusher plate 1510.

At 1810, the body 1202 of material used to form the supporting layer 102 is compressed between the middle and pusher plates 1504, 1510. For example, the pusher plate 1510 may be moved toward the middle plate 1504 such that the body 1202 of material is compressed between the pusher and middle plates 1510, 1504 and is injected through the orifices 1508 of the middle plate 1504 into the mold cavity 1500 between the middle plate 1504 and the exposed layer 104. Heat is applied to the material of the body 1202 in the mold cavity 1500. The pressure and heat applied to this material cures the material into the supporting layer 102. The supporting layer 102 is bonded to the exposed layer 104 to form the protective layer 100. At 1812, the pusher and middle plates 1510, 1504, and the protective body 100 are removed from the mold cavity 1500.

In an embodiment, a protective body for a heat sealing system is provided. The protective body includes a flexible supporting layer and an exposed layer. The flexible supporting layer has opposite first and second sides. The first side is configured to be coupled to a tool of a heat sealing system. The heat sealing system is configured to heat seal a film to a container to enclose the container or to heat seal two or more films together. The exposed layer has a lower coefficient of friction than the supporting layer and is bonded to the second side of the supporting layer. The exposed layer is configured to prevent the film that is being heat sealed to the container from sticking to the tool when the heat sealing system heat seals the film to the container, or to prevent the two or more films that are heat sealed together by the heat sealing system from sticking to the tool when the heat sealing system heat seals the two or more films together.

In another aspect of the protective body, the supporting layer is formed from thermally conductive silicone.

In another aspect of the protective body, the exposed layer is formed from polytetrafluoroethylene (PTFE).

In another aspect of the protective body, the tool of the heat sealing system is a mounting mechanism of a seal head and the heat sealing system includes a supporting tool. The seal head is configured to apply heat and pressure to the film that is being heat sealed to the container while the supporting tool holds the container. The supporting layer is configured to be bonded to the mounting mechanism of the seal head and the exposed layer is configured to prevent the film that is being heat sealed to the container from sticking to the mounting mechanism of the seal head after heat sealing the film to the container.

In another aspect of the protective body, the tool of the heat sealing system is a supporting tool configured to hold the container while a seal head of the heat sealing system applies heat and pressure to the film that is being heat sealed to the container. The supporting layer and the exposed layer are formed together as a gasket that is configured to be disposed between the container and the supporting tool. The exposed layer also is configured to prevent the container from sticking to the supporting tool after heat sealing the film to the container.

In another aspect of the protective body, the tool of the heat sealing system is an elongated first seal bar and the heat sealing system includes an elongated second seal bar that opposes the first seal bar. The heat sealing system is configured to heat seal the two or more films together by applying heat and pressure to the two or more films when the two or more films are moved between the first and second seal bars. The supporting layer is configured to be coupled to the first seal bar and the exposed layer is configured to prevent contents from a bag formed by the two or more films from sticking to the first seal bar.

In another embodiment, a method (e.g., for providing a protective body of a heat sealing system) includes positioning a polytetrafluoroethylene (PTFE) layer into a mold, loading non-vulcanized silicone material onto the PTFE layer, placing a mounting mechanism onto the non-vulcanized silicone material, and applying at least one of heat or pressure to the silicone material to form a silicone layer that is bonded to the PTFE layer and to the mounting mechanism. The silicone layer and the PTFE layer form the protective body that is configured to be connected to a tool of a heat sealing system that is configured to heat seal a film to a container to enclose the container or to a tool of a heat sealing system that is configured to heat seal two or more films together. The PTFE layer is configured to prevent at least one of the films being heat sealed to the container or the two or more films from sticking to the tool when the heat sealing system heat seals the film to the container or the two or more films together.

In another aspect of the method, the silicone layer is formed from thermally conductive silicone.

In another aspect of the method, the tool of the heat sealing system is a mounting mechanism of a seal head and the heat sealing system includes a supporting tool. The seal head configured to apply heat and pressure to the film while the supporting tool holds the container. The silicone layer is configured to be bonded to the mounting mechanism of the seal head and the PTFE layer is configured to prevent the film from sticking to the seal head after heat sealing the film to the container.

In another aspect of the method, the tool of the heat sealing system is a seal head and the heat sealing system includes a supporting tool, the seal head configured to apply heat and pressure to the film while the supporting tool holds the container, and wherein the protective body is formed as a gasket configured to be disposed between the container and the supporting tool, the PTFE layer also configured to prevent the container from sticking to the supporting tool after heat sealing the film to the container.

In another aspect of the method, the tool of the heat sealing system is an elongated first seal bar and the heat sealing system includes an elongated second seal bar that opposes the first seal bar. The heat sealing system is configured to heat seal the two or more films together by applying heat and pressure to the two or more films when the two or more films are moved between the first and second seal bars. The silicone layer is configured to bond to the first seal bar and the PTFE layer is configured to prevent contents from a bag formed by the two or more films from sticking to the first seal bar.

In another embodiment, a seal head for a heat sealing system includes a mounting mechanism, a flexible supporting layer, and exposed layer. The mounting mechanism is configured to move toward a supporting tool of the heat sealing system that is configured to hold a container. The mounting mechanism is configured to move toward the supporting tool to apply pressure to a film being heat sealed to the container. The supporting layer is configured to be bonded to the mounting mechanism. The exposed layer is configured to be bonded to the supporting layer such that the supporting layer is disposed between the mounting mechanism and the exposed layer. The exposed layer is configured to prevent the film being heat sealed to the container from sticking to the mounting mechanism when the heat sealing system heat seals the film to the container and the mounting mechanism moves away from the supporting tool.

In one aspect of the seal head, the supporting layer is formed from thermally conductive silicone.

In one aspect of the seal head, the exposed layer is formed from polytetrafluoroethylene (PTFE).

In one aspect of the seal head, the supporting layer is configured to be removed from the mounting mechanism and the mounting mechanism is configured to then be positioned within a mold in order to vulcanize silicone material to the mounting mechanism and form a replacement supporting layer having a replacement exposed layer bonded thereto.

In another embodiment, a protective body (e.g., for a heat sealing system) includes a thermally conductive silicone layer and a polytetrafluoroethylene (PTFE) layer. The silicone layer has opposite first and second sides. The first side is configured to engage a tool of a heat sealing system to couple the supporting layer to the tool. The heat sealing system is configured to heat seal a film to a container to enclose the container or to heat seal two or more films together. The PTFE layer is bonded to the second side of the supporting layer. The silicone layer is configured to couple the PTFE layer to the tool. The PTFE layer is configured to prevent the film being heat sealed to the container when the heat sealing system heat seals the film to the container or to prevent the two or more films from sticking to the tool when the heat sealing system heat seals the two or more films together.

In one aspect of the protective body, the tool of the heat sealing system is a mounting mechanism of a seal head and the heat sealing system includes a supporting tool. The seal head is configured to apply heat and pressure to the film while the supporting tool holds the container. The silicone layer is configured to be bonded to the mounting mechanism of the seal head and the PTFE layer is configured to prevent the film from sticking to the mounting mechanism after heat sealing the film to the container.

In one aspect of the protective body, the tool of the heat sealing system is a mounting mechanism of a seal head and the heat sealing system includes a supporting tool. The seal head is configured to apply heat and pressure to the film while the supporting tool holds the container. The silicone layer is formed as a gasket configured to be disposed between the container and the supporting tool. The PTFE layer also is configured to prevent the container from sticking to the supporting tool after heat sealing the film to the container.

In one aspect of the protective body, the tool of the heat sealing system is an elongated first seal bar and the heat sealing system includes an elongated second seal bar that opposes the first seal bar. The heat sealing system configured to heat seal the two or more films together by applying heat and pressure to the two or more films when the two or more films are moved between the first and second seal bars. The silicone layer is configured to bond to the first seal bar and the PTFE layer is configured to prevent contents from a bag formed by the two or more films from sticking to the first seal bar.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the inventive subject matter and also to enable one of ordinary skill in the art to practice the embodiments of inventive subject matter, including making and using any devices or systems and performing any incorporated methods. The patentable scope of the inventive subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

As used herein, an element or step recited in the singular and proceeded with the word “a” or “an” should be understood as not excluding plural of said elements or steps, unless such exclusion is explicitly stated. Furthermore, references to “an embodiment” of the present inventive subject matter are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

What is claimed is:

1. A protective body comprising:
a flexible supporting layer having opposite first and second sides, the first side configured to be coupled to a tool of a heat sealing system that is configured to at least one of (a) heat seal a film to a container to enclose the container or (b) heat seal two or more films together; and
an exposed layer having a lower coefficient of friction than the supporting layer and bonded to the second side of the supporting layer, wherein the exposed layer is configured to prevent at least one of (1) the film that is being heat sealed to the container from sticking to the tool or (2) the two or more films that are heat sealed together from sticking to the tool.

2. The protective body of claim 1, wherein the supporting layer is formed from thermally conductive silicone.

3. The protective body of claim 1, wherein the exposed layer is formed from polytetrafluoroethylene (PTFE).

4. The protective body of claim 1, wherein the tool of the heat sealing system is a mounting mechanism of a seal head and the heat sealing system includes a supporting tool, the seal head configured to apply heat and pressure to the film that is being heat sealed to the container while the supporting tool holds the container, and wherein the supporting layer is configured to be bonded to the mounting mechanism of the seal head and the exposed layer is configured to prevent the film that is being heat sealed to the container from sticking to the mounting mechanism of the seal head after heat sealing the film to the container.

5. The protective body of claim 1, wherein the tool of the heat sealing system is a supporting tool configured to hold the container while a seal head of the heat sealing system applies heat and pressure to the film that is being heat sealed to the container, and wherein the supporting layer and the exposed layer are formed together as a gasket that is configured to be disposed between the container and the supporting tool, the exposed layer also configured to prevent the container from sticking to the supporting tool after heat sealing the film to the container.

6. The protective body of claim 1, wherein the tool of the heat sealing system is an elongated first seal bar and the heat sealing system includes an elongated second seal bar that opposes the first seal bar, the heat sealing system configured to heat seal the two or more films together by applying heat and pressure to the two or more films when the two or more films are moved between the first and second seal bars, and the supporting layer is configured to be coupled to the first seal bar and the exposed layer is configured to prevent contents from a bag formed by the two or more films from sticking to the first seal bar.

7. A method for making a protective body, the method comprising the steps of:
positioning a polytetrafluoroethylene (PTFE) layer into a mold;
loading non-vulcanized silicone material onto the PTFE layer;
placing a mounting mechanism onto the non-vulcanized silicone material; and
applying at least one of heat or pressure to the silicone material to form a silicone layer that is bonded to the PTFE layer and to the mounting mechanism, wherein the silicone layer and the PTFE layer form a protective body configured to be connected to a tool of a heat sealing system that is configured to heat seal at least one film to a container to enclose the container or heat seal two or more films together, the PTFE layer configured to prevent at least one of the films being heat sealed to the container or the two or more films from sticking to the tool when the heat sealing system heat seals the film to the container or the two or more films together.

8. The method of claim 7, wherein the silicone layer is formed from thermally conductive silicone.

9. The method of claim 7, wherein the tool of the heat sealing system is a mounting mechanism of a seal head and the heat sealing system includes a supporting tool, the seal head configured to apply heat and pressure to the film while the supporting tool holds the container, and wherein the silicone layer is configured to be bonded to the mounting mechanism of the seal head and the PTFE layer is configured to prevent the film from sticking to the seal head after heat sealing the film to the container.

10. The method of claim 7, wherein the tool of the heat sealing system is a supporting tool configured to hold the container while a seal head applies heat and pressure to the film, and wherein the protective body is formed as a gasket configured to be disposed between the container and the supporting tool, the PTFE layer also configured to prevent the container from sticking to the supporting tool after heat sealing the film to the container.

11. The method of claim 7, wherein the tool of the heat sealing system is an elongated first seal bar and the heat sealing system includes an elongated second seal bar that opposes the first seal bar, the heat sealing system configured to heat seal the two or more films together by applying heat and pressure to the two or more films when the two or more films are moved between the first and second seal bars, and the silicone layer is configured to bond to the first seal bar and the PTFE layer is configured to prevent contents from a bag formed by the two or more films from sticking to the first seal bar.

12. A seal head for a heat sealing system, the seal head comprising:
a mounting mechanism configured to move toward a supporting tool of the heat sealing system that is configured to hold a container, the mounting mechanism configured to move toward the supporting tool to apply pressure to a film being heat sealed to the container;
a flexible supporting layer configured to be bonded to the mounting mechanism; and
an exposed layer configured to be bonded to the supporting layer such that the supporting layer is disposed between the mounting mechanism and the exposed layer, wherein the exposed layer is configured to prevent the film being heat sealed to the container from sticking to the mounting mechanism when the heat sealing system heat seals the film to the container and the mounting mechanism moves away from the supporting tool.

13. The seal head of claim 12, wherein the supporting layer is formed from thermally conductive silicone.

14. The seal head of claim 12, wherein the exposed layer is formed from polytetrafluoroethylene (PTFE).

15. The seal head of claim 12, wherein the supporting layer is configured to be removed from the mounting mechanism and the mounting mechanism is configured to then be positioned within a mold in order to vulcanize silicone material to the mounting mechanism and form a replacement supporting layer having a replacement exposed layer bonded thereto.

16. A protective body comprising:
a thermally conductive silicone layer having opposite first and second sides, the first side configured to engage a tool of a heat sealing system to couple the supporting layer to the tool, the heat sealing system configured to heat seal at least one film to a container to enclose the container or two or more films together; and
a polytetrafluoroethylene (PTFE) layer bonded to the second side of the supporting layer, wherein the silicone layer is configured to couple the PTFE layer to the tool, and the PTFE layer is configured to prevent at least one of the films being heat sealed to the container or the two or more films from sticking to the tool when the heat sealing system heat seals the film to the container or the two or more films together.

17. The protective body of claim 16, wherein the tool of the heat sealing system is a mounting mechanism of a seal head and the heat sealing system includes a supporting tool, the seal head configured to apply heat and pressure to the film while the supporting tool holds the container, and wherein the silicone layer is configured to be bonded to the mounting mechanism of the seal head and the PTFE layer is configured to prevent the film from sticking to the mounting mechanism after heat sealing the film to the container.

18. The protective body of claim 16, wherein the tool of the heat sealing system is a mounting mechanism of a seal head and the heat sealing system includes a supporting tool, the seal head configured to apply heat and pressure to the film while the supporting tool holds the container, and wherein the silicone layer is formed as a gasket configured to be disposed between the container and the supporting tool, the PTFE layer also configured to prevent the container from sticking to the supporting tool after heat sealing the film to the container.

19. The protective body of claim 16, wherein the tool of the heat sealing system is an elongated first seal bar and the heat sealing system includes an elongated second seal bar that opposes the first seal bar, the heat sealing system configured to heat seal the two or more films together by applying heat and pressure to the two or more films when the two or more films are moved between the first and second seal bars, and the silicone layer is configured to bond to the first seal bar and the PTFE layer is configured to prevent contents from a bag formed by the two or more films from sticking to the first seal bar.
